(19) United States
(12) Patent Application Publication
(10) Pub. No.: US 2016/0338045 A1
(43) Pub. Date: Nov. 17, 2016

(54) MU-MIMO FOR SINGLE USER DURING ANTENNA SHARING

(71) Applicant: QUALCOMM Incorporated, San Diego, CA (US)

(72) Inventors: Olaf Josef Hirsch, Sunnyvale, CA (US); Youhan Kim, Fremont, CA (US)

(21) Appl. No.: 14/712,636

(22) Filed: May 14, 2015

(51) Int. Cl. H04W 72/04; H04B 7/04

(52) U.S. Cl. CPC H04W 72/0446; H04B 7/0452

(57) ABSTRACT

A method of transmitting a frame of data to a receiving (RX) device with multiple antennas. A transmitting (TX) device encodes a first portion of the data frame for a first MU-MIMO stream, and encodes a second portion of the data frame for a second MU-MIMO stream. The TX device then transmits the first encoded portion via the first MU-MIMO stream to a first antenna of the RX device, and transmits the second encoded portion via the second MU-MIMO stream to a second antenna of the RX device.

### TECHNICAL FIELD

The example embodiments relate generally to wireless communications systems, and specifically to methods of multi-user multiple-input multiple-output communications.

### BACKGROUND OF RELATED ART

A wireless local area network (WLAN) may be formed by one or more access points (APs) that provide a shared wireless communication medium for use by a number of client devices such as mobile stations (STAs). Multiple-input multiple-output (MIMO) signaling techniques allow an AP to transmit data to the STAs as multiple spatial streams, which may provide many advantages (e.g., higher throughput, extended coverage, increased diversity, and/or interference suppression) over conventional signaling techniques. For example, in a single-user MIMO (SU-MIMO) environment, the AP may use multiple antennas to transmit data to a single STA as multiple spatial streams, and the STA may use multiple antennas to receive the multiple spatial streams. The STA may recover the original data by decoding the received multiple spatial streams.

In SU-MIMO communications, the number of spatial streams transmitted to the STA may depend upon the number of antennas available to the STA. For example, if the STA includes two antennas, then the AP transmit data to the STA as two spatial streams (e.g., according to a 2×2 MIMO configuration); if the STA includes three antennas, then the AP may transmit data to the STA as three spatial streams (e.g., according to a 3×3 MIMO configuration); and so on. Because signal diversity and interference suppression may increase with greater numbers of spatial streams, the AP typically transmits data to the STA using the maximum number of spatial streams supported by the STA. Thus, if the STA indicates (e.g., during association) that it includes two antennas, and thus may support a 2×2 MIMO configuration, the AP may transmit data to the STA using two spatial streams.

Because antenna resources are limited in mobile devices, a STA that supports multiple wireless communication protocols (e.g., WLAN, cellular, and Bluetooth® communications) typically shares its antennas between the multiple wireless communication protocols. Antenna sharing by the STA may degrade MIMO functionality. For example, although a STA may include two antennas (and may therefore support 2×2 MIMO communications), only one of the STA's antennas may be available for WLAN communications at any given time (e.g., because the other antenna may be used for cellular and/or Bluetooth® communications). Because the AP is typically unaware of whether both of the STA's antennas are available for WLAN communications at any given time, the AP may transmit data to the STA as a 2×2 MIMO stream even when only one of the STA's antennas is available for WLAN communications. At such times, the STA may not be able to receive all of the spatial streams transmitted by the AP.

Because SU-MIMO decoding in the STA is based on data received in all of the spatial streams transmitted from the AP, the STA may not be able to recover any of the original data if one or more of the spatial streams are not received (e.g., when one of more of its antennas are not available to receive the spatial streams). As a result, when the STA is in an antenna sharing mode (and thus may not receive all the spatial streams transmitted by the AP), the AP may need to retransmit all of the original data to the STA.

Thus, it would be desirable to reduce the amount of data needed to be retransmitted when a STA does not receive all of the spatial streams transmitted by an AP.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

A method and apparatus for transmitting data from a transmitting (TX) device to a single receiving (RX) device using multi-user multiple-input multiple-output (MU-MIMO) communications are disclosed. The TX device and the RX may each include a plurality of antennas. The TX device may include MU-MIMO encoding circuitry, and the RX device may include MU-MIMO decoding circuitry. To transmit a data frame from a TX device having two antennas to a single RX device having two antennas, the TX device may first divide the data frame into two (i.e., first and second) portions. The TX device may encode the first portion of the data frame onto a first MU-MIMO stream, and may encode the second portion of the data frame onto a second MU-MIMO stream. The first and second MU-MIMO streams may be configured to be independently decodable by the RX device. Then, the TX device may transmit the first MU-MIMO stream to a first antenna of the RX device, and transmit the second MU-MIMO stream to a second antenna of the RX device. The TX device may concurrently transmit the first and second MU-MIMO streams as two spatial streams.

The TX device may determine that the second portion of the data frame was not received by the RX device. For example, the TX device may determine that the second portion of the data frame was not received by the RX device by listening for and/or determining whether one or more block acknowledgement messages are received from the RX device.

In response to determining that the second portion of the data frame was not received by the RX device, the TX device may then retransmit only the second portion of the data frame to the RX device. For example, the TX device may re-encode the second portion of the data frame onto a subsequent MU-MIMO stream, and then transmit the subsequent MU-MIMO stream to the first antenna of the RX device (e.g., because the first antenna of the RX device successfully received the first portion of the data frame, and may be presumed to be available to receive data retransmissions).

As explained in more detail below, the RX device may independently decode the first and second MU-MIMO streams (e.g., and thus independently recover the first and second portions of the data frame). As a result, if the RX device does not receive a portion of the data, then the TX device need only retransmit the “missing” portion of the data (e.g., rather than retransmitting all of the data), thereby reducing traffic associated with data retransmissions, conserving transmit resources in the TX device, and/or conserving receive resources in the RX device.

### BRIEF DESCRIPTION OF THE DRAWINGS

The example embodiments are illustrated by way of example and are not intended to be limited by the figures of the accompanying drawings, where:

FIG. 1 shows an example wireless network within which the example embodiments may be implemented.

FIG. 2 shows an example wireless communication system including a transmitting (TX) device, a receiving (RX) device, and a wireless channel.

FIG. 3A depicts the transmission of data from a TX device to a RX device using multi-user MIMO (MU-MIMO) communications, in accordance with example embodiments.

FIG. 3B depicts the RX device of FIG. 3A receiving a first portion but not a second portion of a data frame transmitted from the TX device of FIG. 3A, in accordance with example embodiments.

FIG. 3C depicts the TX device of FIG. 3A retransmitting the second portion of the data frame to the RX device of FIG. 3A, in accordance with example embodiments.

FIG. 4 shows an example MU-MIMO transmitter for single-user communications.

FIG. 5 shows an example MU-MIMO receiver for single-user communications.

FIG. 6 shows a transmitting device in accordance with example embodiments.

FIG. 7 shows a receiving device in accordance with example embodiments.

FIG. 8 shows a flowchart depicting an example operation for transmitting data encoded as MU-MIMO streams to a single RX device.

FIG. 9 shows a flowchart depicting an example operation for transmitting a data frame using multiple MU-MIMO streams.

FIG. 10 shows a flowchart depicting an example operation for recovering a data frame from multiple MU-MIMO streams.

### DETAILED DESCRIPTION

The example embodiments are described below in the context of Wi-Fi enabled devices for simplicity only. It is to be understood that the example embodiments are equally applicable to other wireless networks (e.g., cellular networks, pico networks, femto networks, satellite networks), as well as for systems using signals of one or more wired standards or protocols (e.g., Ethernet and/or HomePlug/PLC standards). As used herein, the terms “wireless local area network (WLAN)” and “Wi-Fi” can include communications governed by the IEEE 802.11 standards, BLUETOOTH® (Bluetooth), HiperLAN (a set of wireless standards, comparable to the IEEE 802.11 standards, used primarily in Europe), and other technologies used in wireless communications. In addition, although described herein in terms of exchanging data frames between wireless devices, the example embodiments may be applied to the exchange of any data unit, packet, and/or frame between wireless devices. Thus, the term “frame” may include any frame, packet, or data unit such as, for example, protocol data units (PDUs), MAC protocol data units (MPDUs), and physical layer convergence procedure protocol data units (PPDUs). The term “A-MPDU” may refer to aggregated MPDUs.

In the following description, numerous specific details are set forth such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present embodiments. However, it will be apparent to one skilled in the art that these specific details may not be required to practice the present embodiments. In other instances, well-known circuits and devices are shown in block diagram form to avoid obscuring the present disclosure. Any of the signals provided over various buses described herein may be time-multiplexed with other signals and provided over one or more common buses. Additionally, the interconnection between circuit elements or software blocks may be shown as buses or as single signal lines. Each of the buses may alternatively be a single signal line, and each of the single signal lines may alternatively be buses, and a single line or bus might represent any one or more of a myriad of physical or logical mechanisms for communication between components. Embodiments of this disclosure are not to be construed as limited to specific examples described herein but rather to include within their scope all embodiments defined by the appended claims.

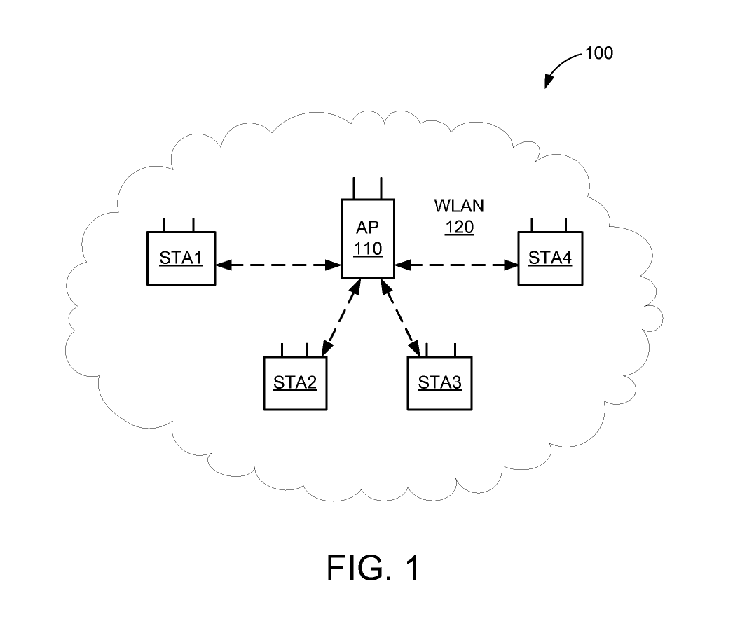

FIG. 1 is a block diagram of a wireless network system 100 within which the example embodiments may be implemented. The system 100 is shown to include four wireless stations STA1-STA4, a wireless access point (AP) 110, and a wireless local area network (WLAN) 120. The WLAN 120 may be formed by a plurality of Wi-Fi access points (APs) that may operate according to the IEEE 802.11 family of standards (or according to other suitable wireless protocols). Thus, although only one AP 110 is shown in FIG. 1 for simplicity, it is to be understood that WLAN 120 may be formed by any number of access points such as AP 110. The AP 110 is assigned a unique MAC address that is programmed therein by, for example, the manufacturer of the access point. Similarly, each of STA1-STA4 is also assigned a unique MAC address. For some embodiments, the wireless system 100 may correspond to a multiple-input multiple-output (MIMO) wireless network.

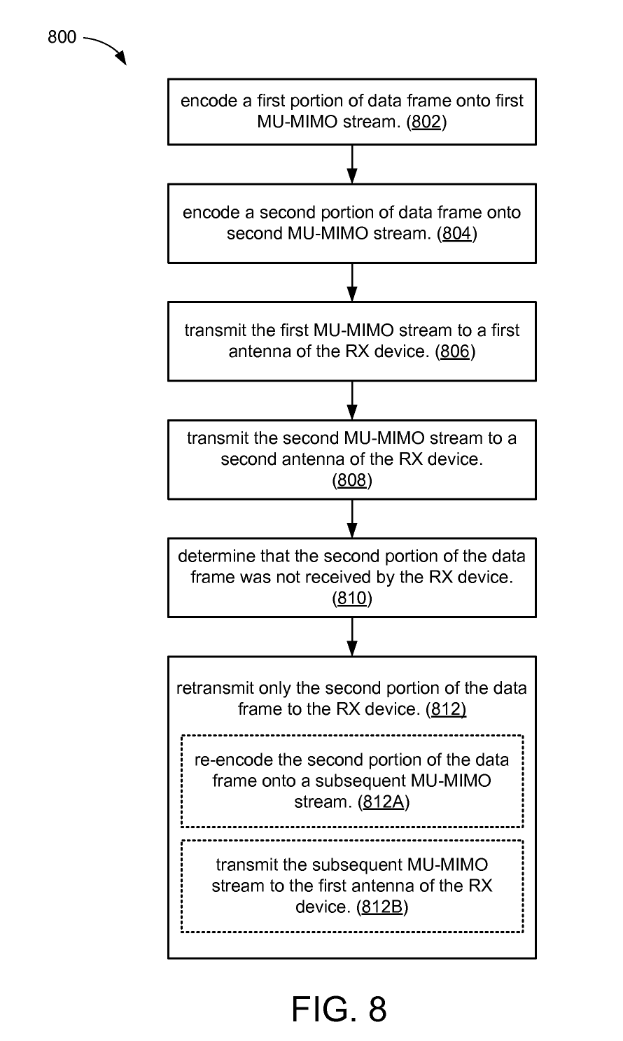

Each of stations STA1-STA4 may be any suitable Wi-Fi enabled wireless device including, for example, a cell phone, personal digital assistant (PDA), tablet device, laptop computer, or the like. Each station STA may also be referred to as a user equipment (UE), a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. For at least some embodiments, each station STA may include one or more transceivers, one or more processing resources (e.g., processors and/or ASICs), one or more memory resources, and a power source (e.g., a battery). The memory resources may include a non-transitory computer-readable medium (e.g., one or more nonvolatile memory elements, such as EPROM, EEPROM, Flash memory, a hard drive, etc.) that stores instructions for performing operations described below with respect to FIGS. 8-10.

The one or more transceivers may include Wi-Fi transceivers, Bluetooth transceivers, cellular transceivers, and/or other suitable radio frequency (RF) transceivers (not shown for simplicity) to transmit and receive wireless communication signals. Each transceiver may communicate with other wireless devices in distinct operating frequency bands and/or using distinct communication protocols. For example, the Wi-Fi transceiver may communicate within a 2.4 GHz frequency band and/or within a 5 GHz frequency band in accordance with the IEEE 802.11 specification. The cellular transceiver may communicate within various RF frequency bands in accordance with a 4G Long Term Evolution (LTE) protocol described by the 3rd Generation Partnership Project (3GPP) (e.g., between approximately 700 MHz and approximately 3.9 GHz) and/or in accordance with other cellular protocols (e.g., a Global System for Mobile (GSM) communications protocol). In other embodiments, the transceivers included within stations STA1-STA4 may be any technically feasible transceiver such as a ZigBee transceiver described by a specification from the ZigBee specification, a WiGig transceiver, and/or a HomePlug transceiver described a specification from the HomePlug Alliance.

The AP 110 may be any suitable device that allows one or more wireless devices to connect to a network (e.g., a local area network (LAN), wide area network (WAN), metropolitan area network (MAN), and/or the Internet) via AP 110 using Wi-Fi, Bluetooth, or any other suitable wireless communication standards. For at least one embodiment, AP 110 may include one or more transceivers, a network interface, one or more processing resources, and one or more memory resources. The one or more transceivers may include Wi-Fi transceivers, Bluetooth transceivers, cellular transceivers, and/or other suitable radio frequency (RF) transceivers (not shown for simplicity) to transmit and receive wireless communication signals. Each transceiver may communicate with other wireless devices in distinct operating frequency bands and/or using distinct communication protocols. The memory resources may include a non-transitory computer-readable medium (e.g., one or more nonvolatile memory elements, such as EPROM, EEPROM, Flash memory, a hard drive, etc.) that stores instructions for performing operations described operations described above or below with respect to FIGS. 8-10.

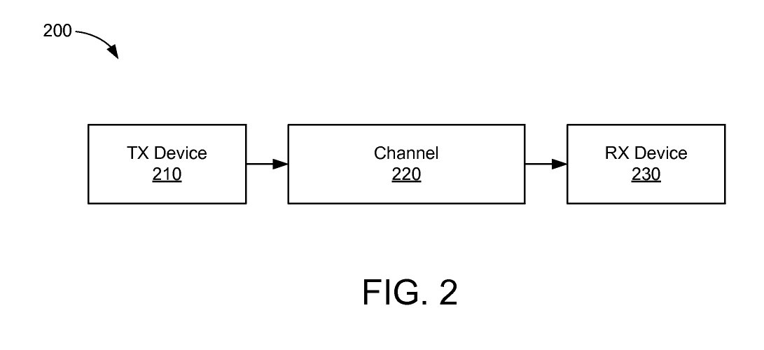

FIG. 2 shows an example communications system 200 including a TX device 210, a RX device 230, and a wireless channel 220. For purposes of discussion herein, the TX device 210 may be the AP 110 of FIG. 1, and the RX device 230 may be one of the stations STA1-STA4 of FIG. 1. For another embodiment, the TX device 210 may be a STA, and the RX device 230 may be an AP. For yet another embodiment, both the TX device 210 and the RX device 230 may be APs. For still another embodiment, both the TX device 210 and the RX device 230 may be STAs.

As depicted in FIG. 2, the TX device 210 transmits signals onto a channel 220, and the RX device 230 receives the signals via the channel 220. As mentioned above with respect to FIG. 1, the WLAN 120 may provide MIMO functionality. As such, the TX device 210 and RX device 230 may each be configured for MIMO communications, for example, so that TX device 210 may transmit multiple streams of data, concurrently, to the RX device 230. MIMO communications between a single TX device and a single RX device (e.g., as depicted in FIG. 2) are typically conducted using SU-MIMO techniques. For example, if both the TX device 210 and the RX device 230 include two antennas (not shown in FIG. 2 for simplicity), then the TX device 210 may encode data to be transmitted to RX device 230 as a 2×2 SU-MIMO stream, and then transmit the 2×2 SU-MIMO stream to RX device 230 using two spatial streams. The RX device 230 may receive the two spatial streams, and thereafter decode data contained in the two spatial streams to recover the original data.

Because the data was transmitted to RX device 230 as SU-MIMO encoded data, the RX device 230 uses data received by both of its antennas to recover the original data. More specifically, due to the nature of SU-MIMO encoding techniques, if the RX device 230 does not receive data from both of its antennas (e.g., because one of its antennas is currently being used for other communication protocols), the RX device 230 may not be able to recover any of the transmitted data. Thus, when the RX device 230 is in an antenna sharing mode and does not receive all of the transmitted data, the TX device 210 typically retransmits all of the data to the RX device 230. Retransmitting all of the data to the RX device 230, even when the RX device 230 receives a portion of the data, undesirably consumes transmit resources in the TX device 210, undesirably consumes receive resources in the RX device 230, and undesirably consumes bandwidth of the wireless channel 230.

In accordance with example embodiments, the TX device 210 may encode data to be transmitted to the RX device 230 using multi-user MIMO (MU-MIMO) encoding techniques, and the RX device 230 may decode the received data using MU-MIMO decoding techniques. More specifically, the TX device 210 may encode data to be transmitted to the RX device 230 into a plurality of MU-MIMO streams, with each of the plurality of MU-MIMO streams assigned to a corresponding one of a plurality of antennas of the RX device. As explained in more detail below, using MU-MIMO techniques to encode data to be transmitted to RX device 230 allows the TX device 210 to direct each of the MU-MIMO streams to a corresponding antenna of the RX device 230. The RX device 230 may independently decode each of the received MU-MIMO streams (e.g., without regard to the other MU-MIMO streams), which in turn allows the RX device 230 to recover portions of the transmitted data associated with the received MU-MIMO streams. Thus, if the RX device 230 does not receive data associated with a particular MU-MIMO stream (e.g., because the receive antenna “assigned” to the particular MU-MIMO stream is unavailable), the TX device 210 need only retransmit the particular MU-MIMO stream (rather than retransmitting all of the data). In this manner, using MU-MIMO signaling techniques to transmit data in a single user environment (i.e., from a TX device to a single RX device) may reduce the amount of data to be retransmitted when the RX device does not receive all of the transmitted data.

MU-MIMO signaling techniques, which are described in the IEEE 802.11 ac specification, were primarily developed to allow a TX device to transmit a plurality of different data streams to a plurality of different RX devices at the same time. For example, referring also to FIG. 1, MU-MIMO signaling techniques allow the AP 110 to transmit different data streams to multiple stations STA1-STA4 at the same time, thereby allowing the AP 110 to independently communicate with the multiple STAs at the same time. More specifically, to transmit different data frames to each of stations STA1-STA4 at the same time, the AP 110 may encode the different data frames into a plurality of different MU-MIMO streams, with each of the different MU-MIMO streams directed at a corresponding one of the stations STA1-STA4. Each of the stations STA1-STA4 may use MU-MIMO decoding techniques to independently decode a corresponding one of the different MU-MIMO streams, for example, so that each of the stations STA1-STA4 may receive its intended data without regard to decoding operations in the other stations.

The example embodiments may leverage MU-MIMO signaling techniques in an SU-MIMO environment to reduce the amount of data to be retransmitted when a RX device does not receive all of the data transmitted by the TX device (e.g., due to unavailability of one or more of the RX device's antennas). More specifically, in accordance with the example embodiments, a TX device may use MU-MIMO encoding to transmit a plurality of MU-MIMO streams to a single RX device, for example, by treating each of the RX device's antennas as a separate RX device. Because the RX device may independently decode each of the plurality of MU-MIMO streams (e.g., without receiving any of the other MU-MIMO streams), if the RX device does not receive a portion of the data, then the TX device need only retransmit the “missing” portion of the data (e.g., rather than retransmitting all of the data).

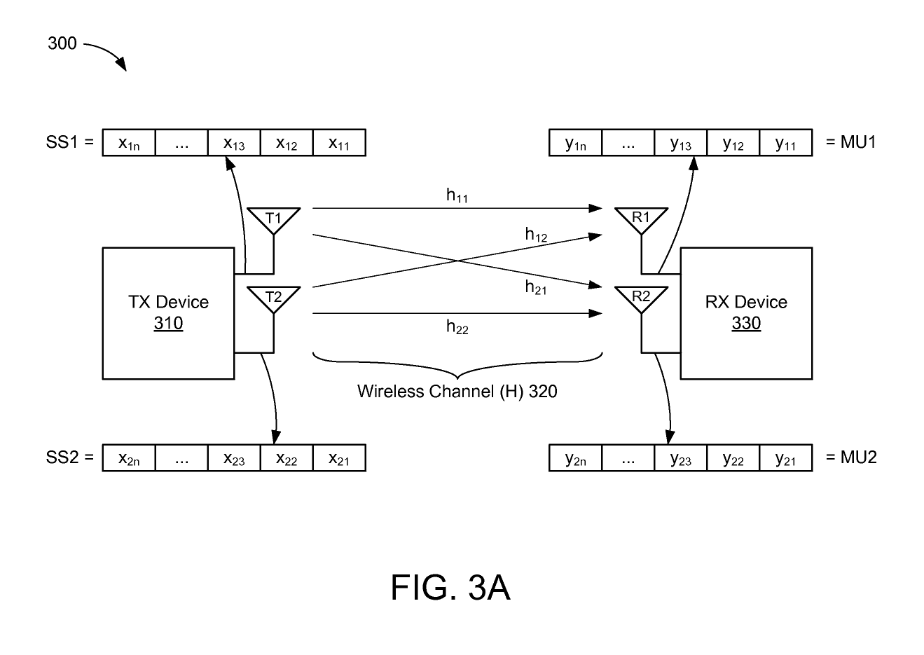

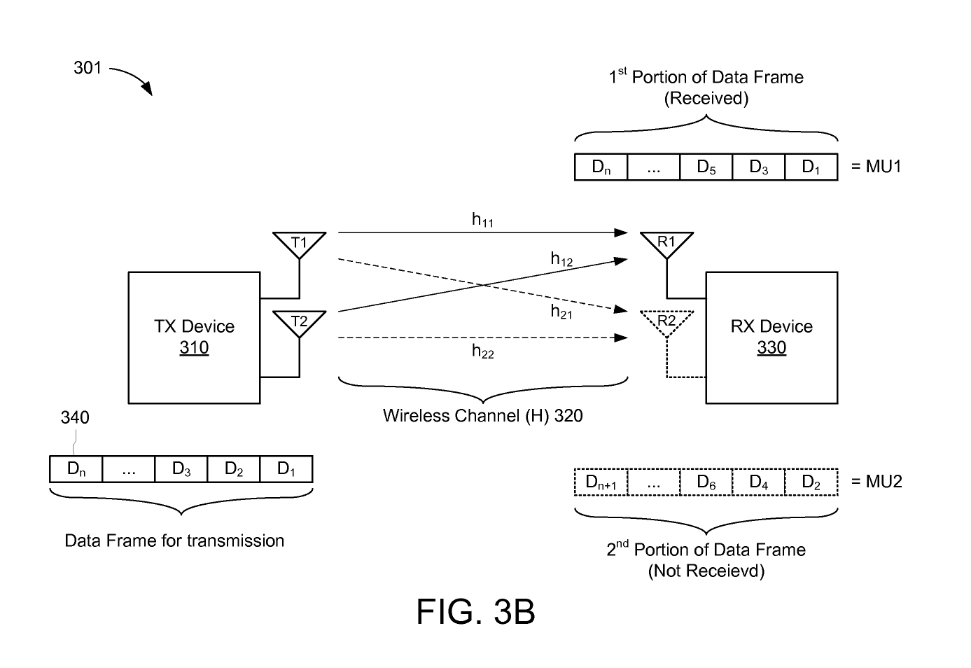

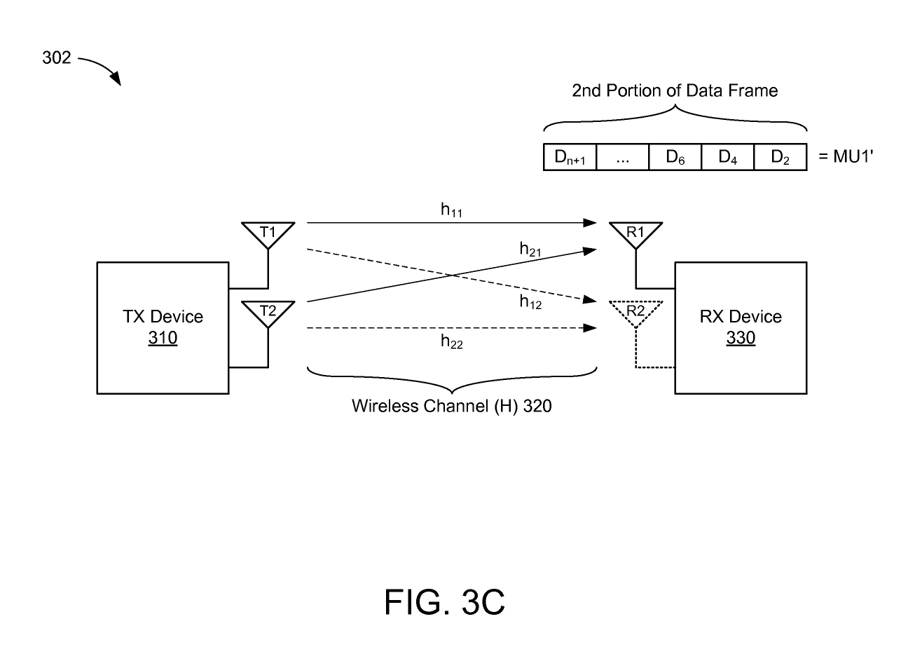

FIG. 3A shows a communications system 300 in accordance with example embodiments. The communications system 300 is shown to include a TX device 310, a wireless channel 320, and an RX device 330. The TX device 310, which may be one embodiment of TX device 210 of FIG. 2, is shown to include two transmit antennas T1 and T2 (although for actual embodiments, TX device 310 may include any suitable number of antennas). The RX device 330, which may be one embodiment of RX device 230 of FIG. 2, is shown to include two receive antennas R1 and R2 (although for actual embodiments, RX device 330 may include any suitable number of antennas). The TX device 310 may utilize both antennas T1 and T2 to transmit multiple streams of data, concurrently, to the antennas R1 and R2 of the RX device 330. For example, through spatial multiplexing, the TX device 310 may transmit a first set of data (e.g., x₁={x₁₁, x₁₂, x₁₃, . . . , x₁ₙ}) on a first spatial stream (SS1) via first transmit antenna T1 while concurrently transmitting a second set of data (e.g., x₂={x₂₁, x₂₂, x₂₃, . . . x₂ₙ}) on a second spatial stream (SS2) via second transmit antenna T2.

Each of the receive antennas R1 and R2 of the RX device 330 may receive a combination of data transmitted by the antennas T1 and T2 of the TX device 310. For example, first receive antenna R1 may receive data from both spatial streams SS1 and SS2, and second receive antenna R2 may also receive data from both spatial streams SS1 and SS2. Channel conditions of the wireless channel 320 and/or spatial orientation of the receive antennas R1-R2 may cause differences in the data patterns received by each of the receive antennas R1-R2. Thus, the data received by first receive antenna R1 (denoted as {y₁₁, y₁₂, y₁₃, . . . , y₁ₙ}) may differ from the data received by second receive antenna R2 (denoted as y₂ {y₂₁, y₂₂, y₂₃, . . . , y₂ₙ}).

The wireless channel 320 may be modeled as a 2×2 channel matrix H (e.g., or an M×M matrix, for M spatial streams):

$$H = [ \begin{matrix}{h}_{11} & {h}_{12} \\ {h}_{21} & {h}_{22}\end{matrix} ]$$

The received data (y) may be expressed as a function of the transmitted data (x):

y=Hx+n (1)

where y=[y₁ y₂], x=[x₁ x₂], and n is the noise component of the wireless channel 320. Thus, Equation 1 may be rewritten as:

y₁=h₁₁x₁+h₁₂x₂+n₁

y₂=h₂₁x₁+h₂₂x₂+n₂

The representative channel matrix H for the wireless channel 320 may be determined by the TX device 310, for example, based on channel state information (CSI) provided by the RX device 330 (e.g., obtained during channel sounding operations between TX device 310 and RX device 330). The TX device 310 may use the CSI to encode data to be transmitted to RX device 330 in a manner that reduces packet error rates (PERs), thereby improving throughput of the wireless channel 320.

For the example embodiment of FIG. 3A, the TX device 310 may use MU-MIMO encoding techniques to encode data to be transmitted to the RX device 330 as first and second MU-MIMO streams (MU1 and MU2, respectively). The first MU-MIMO stream (MU1) may be encoded for reception by the first receive antenna R1, and the second MU-MIMO stream (MU2) may be encoded for reception by the second receive antenna R2. Thus, for purposes of discussion herein, the TX device 310 may assign the first MU-MIMO stream (MU1) to the first receive antenna R1 of RX device 330, and may assign the second MU-MIMO stream (MU1) to the second receive antenna R2 of RX device 330. The two MU-MIMO streams MU1 and MU2 may be concurrently transmitted from TX device 310 to RX device 330 using spatial streams SS1 and SS2, for example, such that the first MU-MIMO stream is directed to the first receive antenna R1 and the MU-MIMO stream is directed to the second receive antenna R2. The RX device 330 may receive and independently decode the two MU-MIMO streams MU1 and MU2.

FIG. 3B is a depiction 301 of TX device 310 transmitting a data frame 340 to RX device 330. The data frame 340, which includes a plurality of data bits D₁-Dₙ₊₁, is encoded for transmission to RX device 330 as two MU-MIMO streams MU1-MU2. The TX device 310 may divide data frame 340 into first and second portions for transmission to antennas R1 and R2, respectively, of RX device 330. More specifically, the TX device 310 may encode odd numbered bits of data frame 340 (e.g., {D₁, D₃, D₅, . . . , Dₙ}) into the first MU-MIMO stream (MU1), and may encode even numbered bits of data frame 340 (e.g., {D₂, D₄, D₆, . . . , Dₙ₊₁}) into the second MU-MIMO stream (MU2). Although the two MU-MIMO streams MU1-MU2 may be concurrently transmitted from antennas T1 and T2 of TX device 310 as two spatial streams (see also FIG. 3A), the first MU-MIMO stream MU1 is directed to the first receive antenna R1 of RX device 330, and the second MU-MIMO stream MU2 is directed to the second receive antenna R2 of RX device 330. This may allow the RX device 330 to independently decode each of the MU-MIMO streams MU1 and MU2.

For the example of FIG. 3B, the RX device 330 may receive the first MU-MIMO stream MU1 but not the second MU-MIMO stream MU2. The RX device 330 may not receive the second MU-MIMO stream MU2, for example, because the second receive antenna R2 may be unavailable (e.g., used for another communication protocol) when the spatial streams arrive at the second receive antenna R2. Because the TX device 310 encoded data frame 340 for transmission as MU-MIMO streams MU1 and MU2, the RX device 330 may use MU-MIMO decoding techniques to recover the first portion of data frame 340 (e.g., {D₁, D₃, D₅, . . . , Dₙ}) from the first MU-MIMO stream MU1 without receiving the second MU-MIMO stream MU2. As a result, the TX device 310 does not need to retransmit the first portion of data frame 340, but rather only the second portion of data frame 340.

If the RX device 330 does not receive all of the transmitted data, the RX device 330 may inform the TX device 310 as to which portions of the data were received (and/or not received). The TX device 310 may use this information to identify which of the receive antennas of the RX device 330 successfully received data from the original transmission, and may then direct data retransmissions to the identified receive antennas.

For example, FIG. 3C is a depiction 302 of the TX device 310 retransmitting the second portion of data frame 340 to the RX device 330 after identifying the first receive antenna as being available. Because the RX device 330 successfully received the first portion of data frame 340 (e.g., encoded as the first MU-MIMO stream MU1) via the first receive antenna R1, the TX device 310 may assume that the first receive antenna R1 is available to receive WLAN communications. Thus, the TX device 310 may retransmit the second portion of data frame 340 to the first receive antenna R1 of RX device 330 rather than to the second receive antenna R2 of RX device 330 (e.g., because the second receive antenna R2 may still be unavailable). More specifically, for example embodiments, the TX device 310 may re-encode the second portion of data frame 340 (e.g., {D₂, D₄, D₆, . . . , Dₙ₊₁}) as a subsequent MU-MIMO stream (MU1′) directed to the first receive antenna R1 of the RX device 330. The subsequent MU-MIMO stream (MU1′) may be transmitted from TX device 310 to RX device 330 as two spatial streams (see also FIG. 3A), and received by the first receive antenna R1 of the RX device 330. Thereafter, the RX device 330 may decode the subsequent MU-MIMO stream (MU1′) to recover the second portion of data frame 340 (e.g., {D₂, D₄, D₆, . . . , Dₙ₊₁}).

As described above, by using MU-MIMO signaling techniques to encode data for transmission as independent MU-MIMO streams to a single RX device 330, the TX device 310 may optimize throughput of the wireless channel by retransmitting only those portions of the data that were not successfully received by the RX device. More specifically, because the data arriving at each of the receive antennas R1 and R2 may correspond to a separate MU-MIMO stream, the RX device 330 may successfully recover one portion of a data frame even if another portion of the data frame was never received and/or unrecoverable. Accordingly, the bandwidth needed for retransmissions may be reduced. In contrast, when using conventional SU-MIMO communications for transmitting data to RX device 330, the resulting MIMO-encoded data frame is typically decoded using data received by both antennas R1 and R2 of the RX device 330. Thus, if the RX device 330 fails to receive any portion of the data, then all of the data is typically retransmitted.

The example embodiments described above with respect to FIGS. 3A-3C may be employed by any suitable pair of devices that include any suitable number of antennas to reduce the amount of data needed to be retransmitted when one or more portions of the transmitted data are not received by the RX device.

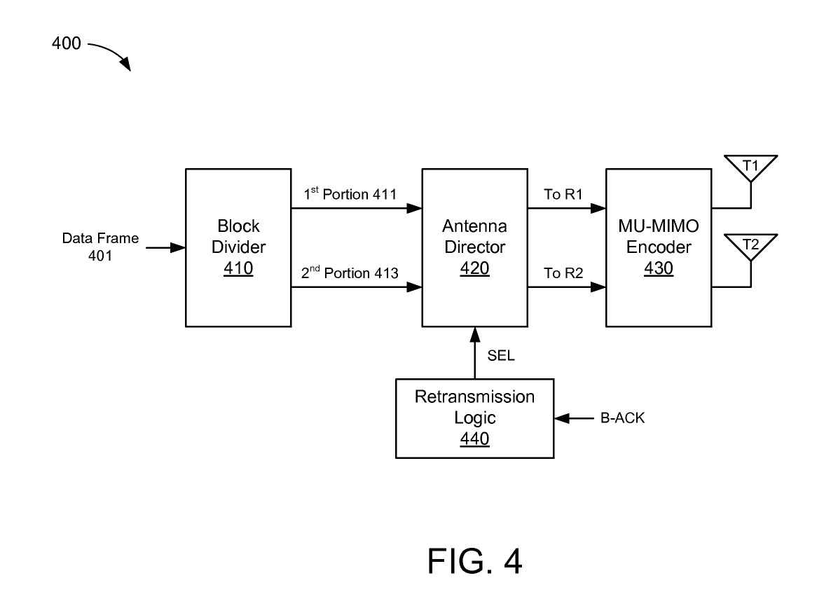

FIG. 4 shows an example MU-MIMO transmitter 400 for single-user communications. For example, the MU-MIMO transmitter 400 may be implemented by TX device 310 (see also FIGS. 3A-3C). The MU-MIMO transmitter 400 includes a block divider 410, an antenna director 420, a MU-MIMO encoder 430, and retransmission logic 440. The block divider 410 receives an outgoing data frame 401 and divides the data frame 401 into a plurality of portions. The block divider 410 may divide the data frame 401 into a number of portions based at least in part on a number of receive antennas of a target RX device (e.g., which may be determined during an association event). For example, if RX device 330 of FIGS. 3A-3C is the target RX device, then the block divider 410 of transmitter 400 may divide the outgoing data frame 401 into a first portion 411 and a second portion 413 (e.g., where the first portion 411 may be directed to first receive antenna R1 of RX device 330, and the second portion 413 may be directed to second receive antenna R2 of RX device 330). For at least some example embodiments, data in the first portion 411 of data frame 401 may be interleaved with data in the second portion 413 of data frame 401 when encoding the data into first and second MU-MIMO streams (MU1 and MU2) for transmission to the RX device 330. The RX device 330 may independently recover the first portion 411 of data frame 401 from the first MU-MIMO stream, and may recover the second portion 413 of data frame 401 from the second MU-MIMO stream.

The antenna director 420 may selectively assign each portion of the data frame 401 to a corresponding receive antenna at the RX device. For example, the first portion 411 of data frame 401 may be assigned to the first receive antenna R1 of RX device 330, and the second portion 413 of data frame 401 may be assigned to the second receive antenna R2 of RX device 330.

The MU-MIMO encoder 430 may encode each portion of the data frame 410 for transmission to the RX device 330 via multiple concurrent spatial streams. More specifically, the MU-MIMO encoder 430 may encode each portion of the data frame 410 as a separate MU-MIMO stream based on the receive antenna assigned to the corresponding portion of data frame 401. For example, the MU-MIMO encoder 430 may encode the first portion 411 of data frame 401 as a first MU-MIMO stream directed at (e.g., intended for reception by) first receive antenna R1 of RX device 330, and may encode the second portion 413 of data frame 401 as a second MU-MIMO stream directed at (e.g., intended for reception by) second receive antenna R2 of RX device 330. The first and second MU-MIMO streams may be transmitted from the transmitter 400 as multiple spatial streams from transmit antennas T1 and T2.

The retransmission logic 440 may determine whether one or more portions of the data frame 401 are to be retransmitted. For example, the retransmission logic 440 may receive a block acknowledgement (B-ACK) message from the RX device 330 in response to the transmitted data frame 401. The retransmission logic 440 may determine that a particular portion of the data frame 401 was not received by the RX device 330 if a B-ACK message corresponding to the particular portion is not received from the RX device 330. Alternatively, the retransmission logic 440 may determine that a particular portion of data frame 401 was not received by RX device 330 in response to receiving a B-ACK message indicating that the particular portion was not received. In response to determining that one or more portions of the data frame 401 were not successfully received by the RX device 330, the retransmission logic 440 may instruct the MU-MIMO transmitter 400 to retransmit the undelivered portion(s) of the data frame 401 to the RX device 330.

For example embodiments, the retransmission logic 440 may redirect the undelivered portion(s) of data frame 401 to a different receive antenna of RX device 330. More specifically, upon retransmission, the undelivered portions of data frame 401 may be directed to one or more receive antennas that successfully received other portions of the data frame 401 during the original transmission. For example, the retransmission logic 440 may determine (e.g., from one or more B-ACK messages) that the first portion 411 of data frame 401 was successfully received by RX device 330 but the second portion 413 was not successfully received by RX device 330. Because the first portion 411 of data frame 401 was originally transmitted to first receive antenna R1 of RX device 330, the first receive antenna R1 may be presumed to be available to receive the retransmitted data, and thus the first receive antenna R1 may be identified as the target antenna for data retransmission. In response thereto, the retransmission logic 440 may cause the MU-MIMO transmitter 400 to retransmit the second portion 413 of data frame 401 to the first receive antenna R1, for example, by setting one or more bits of a select (SEL) signal to identify the first receive antenna R1 as the target antenna for data retransmission. The SEL signal may be provided to antenna director 420 and/or MU-MIMO encoder 430. In response to the SEL signal, the antenna director 420 may re-assign the second portion 413 of data frame 401 to the first receive antenna R1, and the MU-MIMO encoder 430 may re-encode the second portion 413 of data frame 401 onto the first MU-MIMO stream directed at the identified receive antenna (e.g., receive antenna R1).

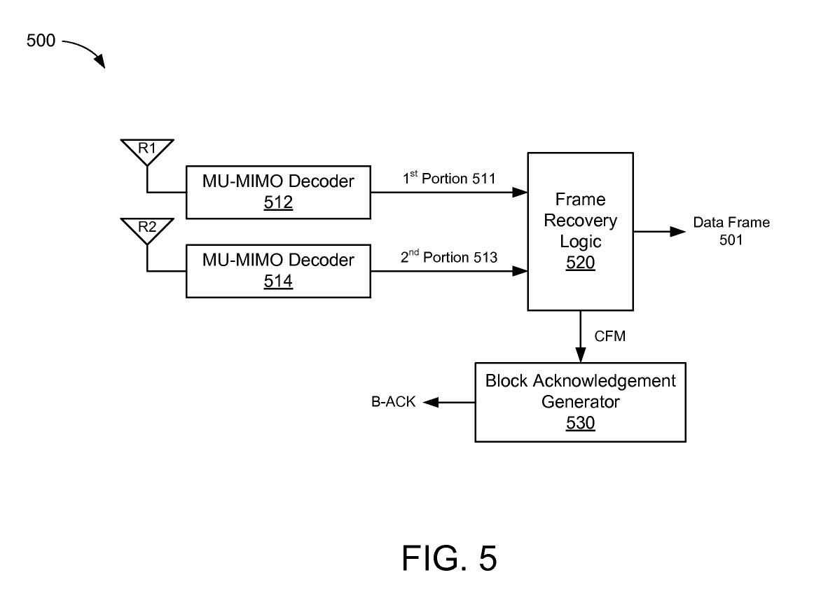

FIG. 5 shows an example MU-MIMO receiver 500 for single-user communications. For example, the MU-MIMO receiver 500 may be implemented by RX device 330, as described above with respect to FIGS. 3A-3C. The MU-MIMO receiver 500 includes a first MU-MIMO decoder 512, a second MU-MIMO decoder 514, frame recovery logic 520, and a block acknowledgement (B-ACK) generator 530. The first MU-MIMO decoder 512 is coupled to first receive antenna R1, and the second MU-MIMO decoder 514 is coupled to second receive antenna R2.

The first MU-MIMO decoder 512 may receive a first MU-MIMO stream via first receive antenna R1, and may decode the first MU-MIMO stream to recover a first portion 511 of a corresponding data frame 501. The recovered (e.g., reconstructed) data frame 501 may represent the original data frame 401 transmitted from the TX device 310. The second MU-MIMO decoder 514 may receive a second MU-MIMO stream via second receive antenna R2, and may decode the second MU-MIMO stream to recover a second portion 513 of data frame 501. The first and second MU-MIMO decoders 512 and 514 may independently decode the received first and second MU-MIMO streams, respectively, which as described above may allow the RX device 330 to recover the first portion 511 of data frame 501 from the first MU-MIMO stream even if the second MU-MIMO decoder 514 does not receive the second MU-MIMO stream (and alternatively, may allow the RX device 330 to recover the second portion 513 of data frame 501 from the second MU-MIMO stream even if the first MU-MIMO decoder 512 does not receive the first MU-MIMO stream).

The frame recovery logic 520 may reconstruct the data frame 501 based on the decoded first and second portions 511 and 513, respectively. For at least some example embodiments, the frame recovery logic 520 may reconstruct the data frame 501 by combining data from the decoded first portion 511 with data from the decoded second portion 513 in an interleaved manner, for example, as such data becomes available. In response to recovering one or more portions of data frame 501, the frame recovery logic 520 may send a confirmation signal (CFM) to the B-ACK generator 530 indicating which (if any) portions of the data frame 501 were successfully recovered. Because the first portion 511 of recovered data frame 501 corresponds to the first portion 411 of the original data frame 401, successful recovery of the first portion 511 may indicate that the RX device 330 successfully received the first MU-MIMO stream via first receive antenna R1; similarly, because the second portion 513 of recovered data frame 501 corresponds to the second portion 413 of the original data frame 401, successful recovery of the second portion 513 may indicate that the RX device 330 successfully received the second MU-MIMO stream via second receive antenna R2.

The B-ACK generator 530 may then transmit one or more B-ACK messages to TX device 310 indicating which (if any) portions of the data frame 401 should be retransmitted by TX device 310. The B-ACK generator 530 may transmit a separate B-ACK message for each successfully received portion of the data frame 501. Alternatively, the B-ACK generator 530 may transmit a single B-ACK message identifying only the successfully received portion(s) of the data frame 501.

If one or more portions of the data frame 501 are missing, the frame recovery logic 520 may hold onto the received portion(s) and wait for the missing portion(s) to be retransmitted by TX device 330. Although not shown in FIG. 5 for simplicity, the frame recovery logic 520 may include or be associated with a suitable memory element (e.g., a buffer or cache memory) to store the decoded portion(s) of the received data. The frame recovery logic 520 may identify which of the RX device's antennas are to receive the retransmitted data (e.g., the missing portions of the original data frame 401), for example, based at least in part on which of the MU-MIMO decoders 512 and 514 was able to successively decode a corresponding one of the MU-MIMO streams and provide a corresponding one of the data portions 511 and 513 to frame recovery logic 520. For example, if the frame recovery logic 520 did not receive the second portion 513 from the second MU-MIMO decoder 514 during the original transmission (e.g., which may indicate that the second receive antenna R2 was not available), then the frame recovery logic 520 may expect to receive the second portion 513 from the first MU-MIMO decoder 512 upon retransmission to the first receive antenna R1. Thus, for at least some example embodiments, the frame recovery logic 520 may buffer or otherwise store the first portion 511 (recovered from the original transmission) until the second portion 513 is recovered from a retransmission. Thereafter, the frame recovery logic 520 may combine the first portion 511 with the second portion 513 to recover the original data frame 401 (e.g., as represented by data frame 501).

The example embodiments are described above with respect to FIGS. 3A-3C and 4-5 for an example 2×2 MIMO configuration for illustrative purposes only; the example embodiments are equally applicable to a pair of TX and RX devices that each include a number N of antennas (and are thus capable of exchanging data using an N×N MIMO configuration. For example, in an N×N MIMO configuration, a TX device may transmit a number N of MU-MIMO streams to a respective number N of receive antennas of an RX device, and the RX device may decode each of the number N of MU-MIMO streams independently of the other number N−1 of MU-MIMO streams.

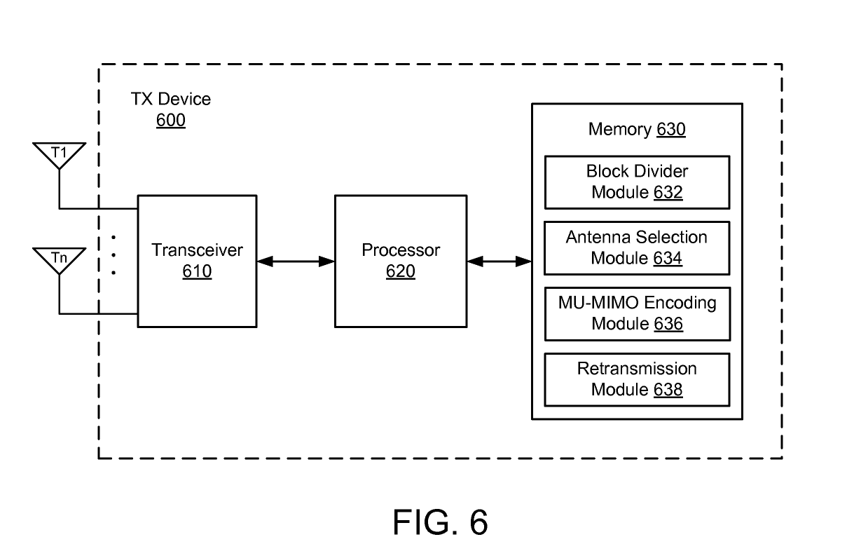

FIG. 6 shows a TX device 600 in accordance with example embodiments. The TX device 600 includes at least a transceiver 610, a processor 620, a memory 630, and a number of transmit antennas T1-Tn. The transceiver 610 may be used to communicate wirelessly with other suitable wireless devices (e.g., including wireless access points and/or wireless stations). The transceiver 610 may include any number of transceiver chains (not shown for simplicity), with each transceiver chain including at least one transmitter 400 of FIG. 4 and at least one receiver 500 of FIG. 5. For example embodiments, the number of transceiver chains provided within transceiver 610 may be based at least in part of the number of antennas T1-Tn provided on TX device 600.

Processor 620, which is coupled to transceiver 610 and memory 630, may be any suitable one or more processors capable of executing scripts or instructions of one or more software programs stored in the TX device 600 (e.g., within memory 630). For purposes of discussion herein, processor 620 is shown in FIG. 6 as being coupled between transceiver 610 and memory 630. For actual embodiments, transceiver 610, processor 620, and/or memory 630 may be connected together using one or more buses (not shown for simplicity).

Memory 630 may include a non-transitory computer-readable medium (e.g., one or more nonvolatile memory elements, such as EPROM, EEPROM, Flash memory, a hard drive, etc.) that may store the following software modules:
a block divider module 632 to divide an outgoing data frame into a plurality of portions based at least in part on a number of antennas of an RX device;
an antenna selection module 634 to assign each portion of the data frame to a respective antenna of the RX device;
an MU-MIMO encoding module 636 to encode each portion of the data frame for transmission via multiple spatial streams; and
a retransmission module 638 to retransmit an undelivered portion of the data frame to a different antenna of the RX device than the antenna that was originally assigned to the undelivered portion.

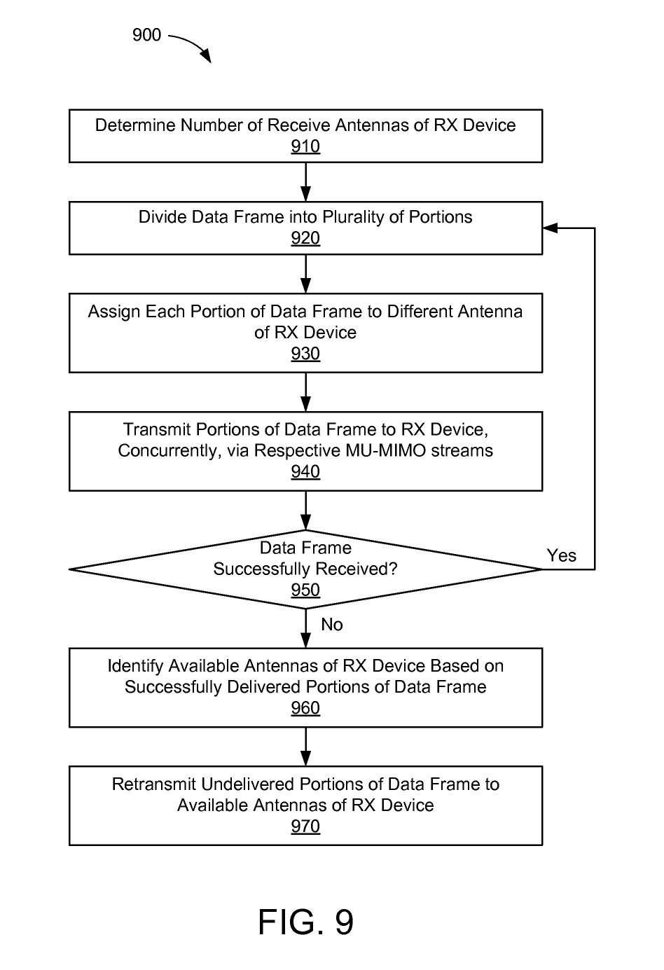

Each software module includes instructions that, when executed by processor 620, causes the TX device 600 to perform the corresponding functions. The non-transitory computer-readable medium of memory 630 thus includes instructions for performing all or a portion of the operations described below with respect to FIGS. 8 and 9.

For example, processor 620 may execute the block divider module 632 to divide an outgoing data frame into a plurality of portions based at least in part on a number of antennas of an RX device. Processor 620 may also execute the antenna selection module 634 to assign each portion of the data frame to a respective antenna of the RX device. Processor 620 may execute the MU-MIMO encoding module 636 to encode each portion of the data frame into a corresponding MU-MIMO stream for transmission to the RX device. Processor 620 may execute the retransmission module 638 to retransmit an undelivered portion of the data frame to a different antenna of the RX device than the antenna that was originally assigned to the undelivered portion.

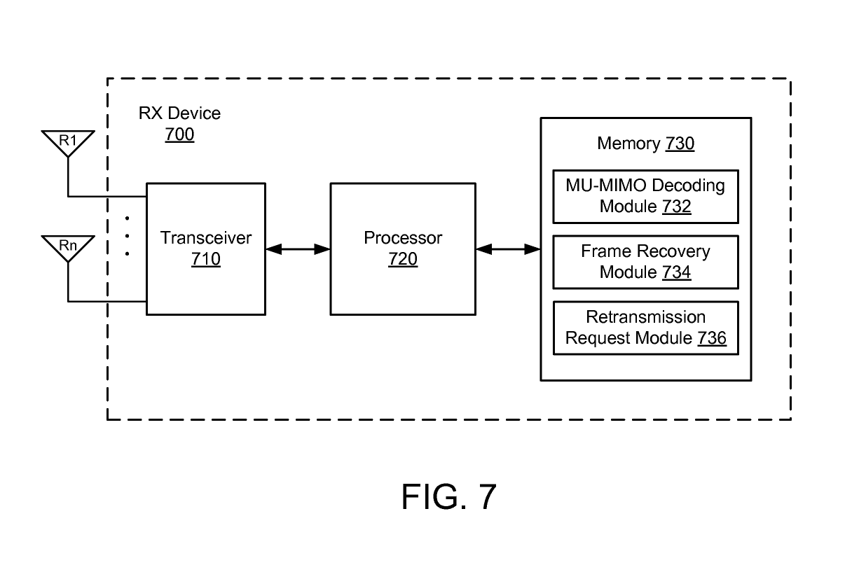

FIG. 7 shows an RX device 700 in accordance with some example embodiments. The RX device 700 includes at least a transceiver 710, a processor 720, a memory 730, a number of receive antennas R1-Rn. The transceiver 710 may be used to communicate wirelessly with other suitable wireless devices (e.g., including wireless access points and/or wireless stations). The transceiver 610 may include any number of transceiver chains (not shown for simplicity), with each transceiver chain including at least one transmitter 400 of FIG. 4 and at least one receiver 500 of FIG. 5. For example embodiments, the number of transceiver chains provided within transceiver 710 may be based at least in part of the number of antennas R1-Rn provided on RX device 700.

Processor 720, which is coupled to transceiver 710 and memory 730, may be any suitable one or more processors capable of executing scripts or instructions of one or more software programs stored in the RX device 700 (e.g., within memory 730). For purposes of discussion herein, processor 720 is shown in FIG. 7 as being coupled between transceiver 710 and memory 730. For actual embodiments, transceiver 710, processor 720, and/or memory 730 may be connected together using one or more buses (not shown for simplicity).

Memory 730 may include a non-transitory computer-readable medium (e.g., one or more nonvolatile memory elements, such as EPROM, EEPROM, Flash memory, a hard drive, etc.) that may store the following software modules:
a MU-MIMO decoding module 732 to recover one or more portions of a data frame from respective MU-MIMO streams received from a TX device;
a frame recovery module 734 to combine the one or more recovered portions into the original data frame; and
a retransmission request module 736 to request retransmission of one or more missing portions of the data frame from the TX device.

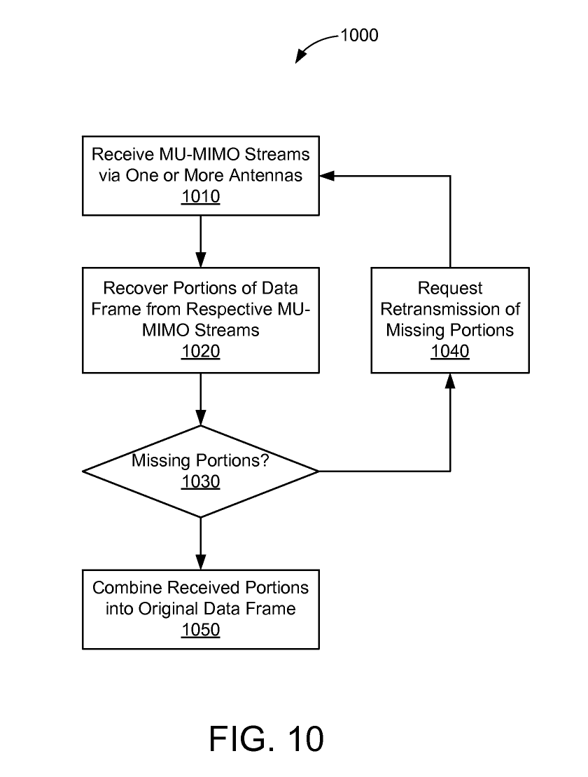

Each software module includes instructions that, when executed by processor 720, causes the RX device 700 to perform the corresponding functions. The non-transitory computer-readable medium of memory 730 thus includes instructions for performing all or a portion of the operations described below with respect to FIG. 10.

For example, processor 720 may execute the MU-MIMO decoding module 732 to recover one or more portions of a data frame from one or more respective MU-MIMO streams received from a TX device. Processor 720 may execute the frame recovery module 734 to combine the one or more portions of the data frame into the original data frame. Processor 720 may execute the retransmission request module 736 to request retransmission of one or more missing portions of the data frame from the TX device (e.g., by sending one or more B-ACK frames to the TX device).

FIG. 8 shows a flowchart depicting an example operation 800 for transmitting a data frame from a TX device to a RX device using MU-MIMO communications. With reference, for example, to FIGS. 3A-3C, the example operation 800 may be performed by the TX device 310 to transmit data to RX device 330 in a manner that allows the TX device 310 to retransmit only those portions of the data frame that were not successfully received by the RX device 330.

The TX device 310 may encode a first portion of the data frame onto a first MU-MIMO stream (802), and may encode a second portion of the data frame onto a second MU-MIMO stream (804). The TX device 310 may encode the data frame using MU-MIMO encoding techniques (e.g., as defined by the IEEE 802.11 ac specification) to enable a different MU-MIMO stream to be transmitted to each of the receive antennas R1 and R2 of the RX device 330. For example, the first MU-MIMO stream may be directed to (e.g., intended for) the first antenna R1 of the RX device 330, and the second MU-MIMO stream may be directed to (e.g., intended for) the second antenna R2 of the RX device 330. As discussed above, this may allow the RX device to independently decode the first and second MU-MIMO streams.

The TX device 310 may transmit the first MU-MIMO stream to the first antenna R1 of the RX device (806), and may transmit the second MU-MIMO stream to the second antenna R2 of the RX device (808). The MU-MIMO streams may be transmitted concurrently as multiple spatial streams.

The TX device 310 may then determine that the second portion of the data frame was not successfully received by the RX device 330 (810). For example embodiments, the TX device 310 may determine that the second portion of the data frame was not successfully received by the RX device 330 by listening for one or more B-ACK messages from the RX device 330. For one example, the TX device 310 may determine that the second portion of the data frame was not received by the RX device 330 if it does not receive a B-ACK message for the second portion of the data frame. Alternatively, the TX device 310 may determine that the second portion of the data frame was not received by the RX device 330 if it receives a B-ACK message confirming receipt of only the first portion of the data frame.

In response to determining that the second portion of the data frame was not successfully received by the RX device 330 (810), the TX device 310 may retransmit only the second portion of the data frame to the RX device 330 (812). For example embodiments, the TX device 310 may re-encode the second portion of the data frame onto a subsequent MU-MIMO stream (812A), and then transmit the subsequent MU-MIMO stream to the first antenna R1 of the RX device 330 (812B).

FIG. 9 shows a flowchart depicting another example operation 900 for transmitting a single data frame via multiple MU-MIMO streams. With reference, for example, to FIG. 4, the operation 900 may be performed by the MU-MIMO transmitter 400 to transmit MU-MIMO-encoded data signals to an RX device. The MU-MIMO transmitter 400 may first determine a number of receive antennas of the RX device (910). For example, information about the number of receive antennas may be shared by the RX device during a prior association event.

The MU-MIMO transmitter 400 may then divide an outgoing data frame (e.g., intended for the RX device) into a plurality of portions (920). For example embodiments, the block divider 410 may divide the outgoing data frame into a number of portions based at least in part on the number of receive antennas of the RX device. For example, if the RX device includes two receive antennas, then the block divider may divide the outgoing data frame 401 into a first portion 411 and a second portion 413 (e.g., one for each receive antenna). The data in each of the portions may be interleaved to enable the original data frame to be reconstructed from the plurality of portions, concurrently, at the RX device.

Each portion of the data frame is then assigned to a different antenna of the RX device (930). For example, the antenna director 420 may assign the first portion 411 to the first antenna R1 of the RX device, and may further assign the second portion 413 to the second antenna R2 of the RX device. For some embodiments, the initial antenna assignments may be arbitrary (e.g., as long as each portion of the data frame is assigned to a different receive antenna).

The MU-MIMO transmitter 400 transmits the plurality of portions of the data frame to the RX device, concurrently, via respective MU-MIMO streams (940). For example embodiments, the MU-MIMO encoder 430 may encode each portion of the data frame as a separate MU-MIMO stream based on its assigned antenna. For example, the MU-MIMO encoder 430 may encode the first portion 411 as a first MU-MIMO stream directed at the first antenna R1 of the RX device, and may further encode the second portion 413 as a second MU-MIMO stream directed at the second antenna R2 of the RX device. Each of the MU-MIMO streams may be transmitted on multiple spatial streams (e.g., by antennas T1 and T2, concurrently).

The MU-MIMO transmitter 400 may then determine whether the data frame was successfully received by the RX device (950). For example, the retransmission logic 440 may determine which (if any) portions of the data frame were successfully received based on one or more B-ACK messages sent by the RX device. For some embodiments, the retransmission logic 440 may determine that a particular portion of the data frame 401 was not received by the RX device if it does not receive a B-ACK message for that particular portion. For other embodiments, the retransmission logic 440 may determine that a particular portion of the data frame 401 was not received by the RX device upon receiving a B-ACK message indicating that the particular portion was not received.

If the entire data frame was successfully received by the RX device, as tested at 950, the MU-MIMO transmitter 400 may transmit the next data frame to the RX device (920). However, if one or more portions of the data frame were not received by the RX device, as tested at 950, the MU-MIMO transmitter 400 may identify a number of available antennas of the RX device based on one or more successfully delivered portions of the data frame (960). For example, the MU-MIMO transmitter 400 may identify a number of successfully received portions of the data frame based on one or more B-ACK messages. Because each successfully received portion of the data frame was originally transmitted to a particular antenna of the RX device, the corresponding antennas may be presumed to be available to receive the retransmitted data.

Finally, the MU-MIMO transmitter 400 may retransmit the undelivered portions of the data frame to the available antennas of the RX device (970). During retransmission, the retransmission logic 440 may cause the antenna director 420 to reassign each undelivered portion of the data frame to a different (available) antenna of the RX device than the antenna to which it was originally assigned. For example, if the retransmission logic 440 determines that the first portion 411 (originally assigned to the first antenna R1) was successfully received by the RX device but the second portion 413 (originally assigned to the second antenna R2) was not successfully received, the retransmission logic 440 may instruct the MU-MIMO transmitter 400 to retransmit the second portion 413 to the first antenna R1 of the RX device.

FIG. 10 shows a flowchart depicting an example operation 1000 for recovering a data frame from multiple MU-MIMO streams. With reference, for example, to FIG. 5, the operation 1000 may be performed by the MU-MIMO receiver 500. The MU-MIMO receiver 500 may first receive a number of MU-MIMO streams via one or more antennas (1010). For example, the first MU-MIMO decoder 512 may receive a first MU-MIMO stream via the first antenna R1, and the second MU-MIMO decoder 514 may receive a second MU-MIMO stream via the second antenna R2. The first and second MU-MIMO streams may be received concurrently, and may correspond to a single frame of data.

The MU-MIMO receiver 500 may recover portions of the data frame from the MU-MIMO streams (1020). For example, the first MU-MIMO decoder 512 may decode the first MU-MIMO stream to recover the first portion 511 of the data frame 501, and the second MU-MIMO decoder 514 may decode the second MU-MIMO stream to recover the second portion 513 of the data frame 501. As discussed above, each MU-MIMO stream may be decoded independently of the other MU-MIMO streams. Thus, the first MU-MIMO decoder 512 may successfully recover the first portion 511 of the data frame 501 from the first MU-MIMO stream even if the second MU-MIMO decoder 514 does not receive the second MU-MIMO stream (e.g., due to antenna sharing of the second receive antenna R2).

Upon receiving at least one MU-MIMO stream, the MU-MIMO receiver 500 may determine whether there are any missing portions of the data frame (1030). For example, the frame recovery logic 520 may attempt to reconstruct the original data frame 501 based on the recovered portions. If there are no missing portions, as tested at 1030, the MU-MIMO receiver 500 may successfully combine the received portions into the original data frame 501 (1050). For example, the frame recovery logic 520 may combine the first portion 511 (recovered from the first MU-MIMO stream) with the second portion 513 (recovered from the second MU-MIMO stream) to reconstruct the original data frame 501. For some embodiments, the frame recovery logic 520 may reconstruct the data frame 501 by combining data from the first portion 511 with data from the second portion 513 in an interleaved manner, as such data becomes available.

However, if one or more portions are missing, as tested at 1030, the MU-MIMO receiver 500 may request retransmission of the missing portions from the TX device (1040). For example, if the frame recovery logic 520 is unable to reconstruct the original data frame 501, the frame recovery logic 520 may cause the B-ACK generator 530 to send one or more B-ACK messages indicating which (if any) portions of the data frame 501 are to be retransmitted. For some embodiments, the B-ACK generator 530 may transmit a separate B-ACK message for each successfully received portion of the data frame 501. For other embodiments, the B-ACK generator 530 may transmit a single B-ACK message for the entire data frame 501, identifying only the successfully received portion(s).

The MU-MIMO receiver 500 may wait to receive the missing portions of the data frame via one or more subsequent MU-MIMO streams (1010). For example, the frame recovery logic 520 may hold onto the received portions of the data frame and wait for the missing portions to be retransmitted by the TX device. For some embodiments, the frame recovery logic 520 may expect to receive a missing portion via an antenna chain that successfully received another portion of the data frame 501 during the original transmission. The above-described operation 1000 may be repeated until every portion of the data frame is successfully received by the MU-MIMO receiver 500, and the frame recovery logic 520 is able to reconstruct the entire data frame (1050).

In the foregoing specification, embodiments have been described with reference to specific examples. It will, however, be evident that various modifications and changes may be made thereto without departing from the broader scope of the disclosure as set forth in the appended claims. For example, the method steps depicted in the flow charts of FIGS. 8-10 may be performed in other suitable orders, multiple steps may be combined into a single step, and/or some steps may be omitted (or further steps included). The specification and drawings are, accordingly, to be regarded in an illustrative sense rather than a restrictive sense.

What is claimed is:

1. A method of transmitting a data frame from a first wireless communication device (transmitting (TX) device) to a second wireless communication device (receiving (RX) device) using multi-user multiple-input multiple-output (MU-MIMO) communications, the method comprising:
encoding a first portion of the data frame for a first MU-MIMO stream;
encoding a second portion of the data frame for a second MU-MIMO stream;
transmitting the first encoded portion via the first MU-MIMO stream to a first antenna of the RX device; and
transmitting the second encoded portion via the second MU-MIMO stream to a second antenna of the RX device.

2. The method of claim 1, wherein each of the first MU-MIMO stream and the second MU-MIMO stream is transmitted as an independent MU-MIMO stream.

3. The method of claim 1, wherein the first MU-MIMO stream and the second MU-MIMO stream are concurrently transmitted to the RX device as two spatial streams.

4. The method of claim 1, further comprising:
determining at the TX device that the second portion of the data frame was not received by the RX device; and
retransmitting only the second portion from the first portion and the second portion of the data frame to the RX device.

5. The method of claim 4, wherein the retransmitting comprises:
re-encoding the second portion of the data frame for the first MU-MIMO stream; and
transmitting the second encoded portion via the first MU-MIMO stream to the first antenna of the RX device.

6. The method of claim 4, wherein the retransmitting comprises:
re-encoding the second portion of the data frame for a third MU-MIMO stream; and
transmitting the second encoded portion via the third MU-MIMO stream to a third antenna of the RX device.

7. The method of claim 4, wherein the determining comprises:
receiving, from the RX device, a single block acknowledgement (B-ACK) message indicating if each of the first and second MU-MIMO streams was received by the RX device.

8. The method of claim 4, wherein the TX device is configured to receive a block acknowledgement (B-ACK) message from the RX device for each of the first and second MU-MIMO streams, and wherein the determining that the second portion of the data frame was not received by the RX device is based on a failure to receive a B-ACK message indicating receipt of the second portion of the data frame.

9. A communication device for transmitting a data frame to a another device (receiving (RX) device) using multi-user multiple-input multiple-output (MU-MIMO) communications, the transmitting device comprising:
a number of antennas;
one or more processors; and
a memory storing instructions that, when executed by the one or more processors, cause the transmitting device to:
encode a first portion of the data frame for a first MU-MIMO stream;
encode a second portion of the data frame for a second MU-MIMO stream;
transmit the first encoded portion via the first MU-MIMO stream to a first antenna of the RX device; and
transmit the second encoded portion via the second MU-MIMO stream to a second antenna of the RX device.

10. The communication device of claim 9, wherein each of the first MU-MIMO stream and the second MU-MIMO stream is transmitted as an independent MU-MIMO stream.

11. The communication device of claim 9, wherein the first MU-MIMO stream and the second MU-MIMO stream are concurrently transmitted to the RX device as two spatial streams.

12. The communication device of claim 9, wherein execution of the instructions causes the communication device to further:
determine that the second portion of the data frame was not received by the RX device; and
retransmit only the second portion from the first portion and the second portion of the data frame to the RX device.

13. The communication device of claim 12, wherein execution of the instructions to retransmit the second portion of the data frame causes the communication device to:
re-encode the second portion of the data frame for the first MU-MIMO stream; and
transmit the second encoded portion via the first MU-MIMO stream to the first antenna of the RX device.

14. The communication device of claim 12, wherein execution of the instructions to retransmit the second portion of the data frame causes the communication device to:
re-encode the second portion of the data frame for a third MU-MIMO stream; and
transmit the second encoded portion via the third MU-MIMO stream to a third antenna of the RX device.

15. The communication device of claim 12, wherein execution of the instructions to determine that the second portion of the data frame was not received by the RX device causes the communication device to:
receive, form the RX device, a single block acknowledgement (B-ACK) message indicating if each of the first and second MU-MIMO streams was received by the RX device.

16. The communication device of claim 12, wherein the communication device is configured to receive a block acknowledgement (B-ACK) message from the RX device for each of the first and second MU-MIMO streams, and wherein the determining that the second portion of the data frame was not received by the RX device is based on a failure to receive a B-ACK message indicating receipt of the second portion of the data frame.

17. A non-transitory computer-readable medium storing instructions that, when executed by one or more processors of a communication device to transmit a data frame to another device (receiving (RX) device) using multi-user multiple-input multiple-output (MU-MIMO) communications, causes the communication device to perform operations comprising:
encoding a first portion of the data frame for a first MU-MIMO stream;
encoding a second portion of the data frame for a second MU-MIMO stream;
transmitting the first encoded portion via the first MU-MIMO stream to a first antenna of the RX device; and
transmitting the second encoded portion via the second MU-MIMO stream to a second antenna of the RX device.

18. The non-transitory computer-readable medium of claim 17, wherein each of the first MU-MIMO stream and the second MU-MIMO stream is transmitted as an independent MU-MIMO stream.

19. The non-transitory computer-readable medium of claim 17, wherein the first MU-MIMO stream and the second MU-MIMO stream are concurrently transmitted to the RX device as two spatial streams.

20. The non-transitory computer-readable medium of claim 17, wherein execution of the instructions causes the communication device to perform operations further comprising:
determining that the second portion of the data frame was not received by the RX device; and
retransmitting only the second portion from the first portion and the second portion of the data frame to the RX device.

21. The non-transitory computer-readable medium of claim 20, wherein execution of the instructions to retransmit the second portion of the data frame causes the communication device to:
re-encode the second portion of the data frame for the first MU-MIMO stream; and
transmit the second encoded portion via the first MU-MIMO stream to the first antenna of the RX device.

22. The non-transitory computer-readable medium of claim 20, wherein execution of the instructions to retransmit the second portion of the data frame causes the communication device to:
re-encode the second portion of the data frame for a third MU-MIMO stream; and
transmit the second encoded portion via the third MU-MIMO stream to a third antenna of the RX device.

23. A communication device for transmitting a data frame to another device (receiving (RX) device) using multi-user multiple-input multiple-output (MU-MIMO) communications, the communication device comprising:
means for encoding a first portion of the data frame for a first MU-MIMO stream;
means for encoding a second portion of the data frame for a second MU-MIMO stream;
means for transmitting the first encoded portion via the first MU-MIMO stream to a first antenna of the RX device; and
means for transmitting the second encoded portion via the second MU-MIMO stream to a second antenna of the RX device.

24. The communication device of claim 23, wherein each of the first MU-MIMO stream and the second MU-MIMO stream is transmitted as an independent MU-MIMO stream.

25. The communication device of claim 23, wherein the first MU-MIMO stream and the second MU-MIMO stream are concurrently transmitted to the RX device as two spatial streams.

26. The communication device of claim 23, further comprising:
means for determining that the second portion of the data frame was not received by the RX device; and
means for retransmitting only the second portion from the first portion and the second portion of the data frame to the RX device.

27. The communication device of claim 26, wherein the means for retransmitting is to:
re-encode the second portion of the data frame for the first MU-MIMO stream; and
transmit the second encoded portion via the first MU-MIMO stream to the first antenna of the RX device.

28. The communication device of claim 26, wherein the means for retransmitting is to:
re-encode the second portion of the data frame for a third MU-MIMO stream; and
transmit the second encoded portion via the third MU-MIMO stream to a third antenna of the RX device.

29. The communication device of claim 26, wherein the means for determining is to determine that the second portion was not received by:
receiving, from the RX device, a single block acknowledgement (B-ACK) message indicating if each of the first and second MU-MIMO streams was received by the RX device.

30. The communication device of claim 26, wherein the TX device is configured to receive a block acknowledgement (B-ACK) message from the RX device for each of the first and second MU-MIMO streams, and wherein the determining that the second portion of the data frame was not received by the RX device is based on a failure to receive a B-ACK message indicating receipt of the second portion of the data frame.
